(19) United States
(12) Patent Application Publication
(10) Pub. No.: US 2009/0292638 A1
(43) Pub. Date: Nov. 26, 2009

(54) Complementary Trading Of Interests

(75) Inventor: Andrew Hausman, Summit, NJ (US)

Correspondence Address: FROMMER LAWRENCE & HAUG, 745 FIFTH AVENUE- 10TH FL., NEW YORK, NY, 10151, US

(73) Assignee: Bloomberg Finance L.P., New York, NY (US)

(21) Appl. No.: 12/536,464

(22) Filed: Aug. 5, 2009

Related U.S. Application Data
(63) Continuation of application No. 12/051,554, filed on Mar. 19, 2008, now abandoned.
Application No. 12/051,554 is a continuation of application No. 10/643,663, filed on Aug. 19, 2003, now abandoned.
(60) Provisional application No. 60/404,789, filed on Aug. 19, 2002.

(51) Int. Cl. G06Q 40/00

(52) U.S. Cl. 705/37

(57) ABSTRACT

Methods, systems, and computer program products for automatically proposing currency exchange, hedging, and other trades in financial interests. A trader proposing or accepting a trade in a financial interest is presented with terms of or a prompt regarding a proposed complementary trade in a related interest.

### RELATED APPLICATION

This application claims the benefit of U.S. provisional patent application No. 60/404,789, filed 19 Aug. 2002 and entitled Complementary Trading of Interests, the entire contents of which are hereby incorporated by reference.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

This application contains material relating to the trading of financial interests. The trading of some financial interests is regulated, as for example by the United States Government, the various state governments, and other governmental agencies within the United States and elsewhere. The disclosure herein is made solely in terms of logical and financial possibility and advantage, without regard to possible statutory, regulatory, or other legal considerations. Nothing herein is intended as a statement or representation of any kind that any method or process proposed or discussed herein does or does not comply with any statute, law, regulation, or other legal requirement whatsoever, in any jurisdiction; nor should it be taken or construed as doing so.

### BACKGROUND OF THE INVENTION

The invention relates to electronic trading of financial interests using computer systems, and in particular to programs, methods, and systems for facilitating and proposing complementary transactions in currency or financial interests in association with transactions in other financial interests.

Trading in financial and other interests occurs in diverse markets. For international traders of financial instruments, for example, this involves the additional risks of international business, such as fluctuations in the exchange rates of the currencies in which terms of traded instruments are expressed, traded, settled, etc. As a result, traders of financial instruments sometimes undertake complementary positions in several different types of financial instruments in order to manage the additional risks. For example, if a trader trades a security that normally trades or settles in a first currency, the trader may also wish to make a complementary trade in another currency. To do so, the trader must determine a suitable complementary position and execute the second trade as well.

Investors in securities and other financial interests also sometimes engage in hedging or other complementary transactions in options, futures, and other financial interests in order to protect investments made through other transactions.

### SUMMARY OF THE INVENTION

The invention provides methods, systems, and computer program products for accommodating payments, hedges, options, and other activities in trading of financial and other interests. A trader proposing or accepting a trade in an interest such as, for example, a present, future, or contingent interest in a stock, bond, contract, debt instrument, commercial paper, negotiable instrument, or energy or other commodity via an electronic communications network, is offered, preferably automatically or in association with a prompt, an opportunity to engage in a second, related trade in another interest, such as a foreign currency or other interest suitable for use in hedging or otherwise complementing supporting, or completing the first transaction, or for providing a benefit based on a relationship to the first trade.

In one embodiment of the invention, an electronic trading system receives from a user station associated by the system with a trader associated by the system with a first currency or monetary system, e.g., that of the United States, an order for the purchase of stocks offered for sale on terms stated in a second monetary system, e.g., that of the European Union. The electronic trading system determines from a data profile associated with the user station and/or the trader entering the order that a default currency used by the trader is the first currency, while the currency in which the price for the stocks is stated is in the second currency. The system automatically presents at the user station from which the order was entered, upon entry of the order for trading of the stock, terms for a proposed trade in the first and second currencies, in order to facilitate payment for or hedging of the stock trade. The proposed transaction is preferably executable by entry of a command or commands at the user station.

The system may automatically present at the user station a prompt enabling the trader to access a foreign exchange trading system and view proposed terms for a trade in dollars and euros, for use, for example, in hedging the proposed transaction or for facilitating payment for the first transaction.

In another embodiment of the invention, a trader proposing or accepting a trade in a first interest, such as a stock, is automatically offered or prompted regarding an opportunity to hedge the trade by trading in a second interest, such as another stock, a bond, a derivative, or other suitable interest, based on a relationship.

Terms such as price, quantity, and the identification of the traded interests (e.g., currency pairs and/or other financial interests), may be firm or negotiable.

In another embodiment of the invention, a method provides to users of an electronic trading system opportunities for currency exchange related to transactions in other interests. The method comprises automatically, or in association with a prompt, presenting to a user who has proposed or accepted a trade in one or more financial interests, for example at a terminal associated with the entry of the order for the trade, an opportunity to engage in a currency or other transaction, e.g, a transaction related to the proposed trade. For example, upon entry of the order for a trade in a non-currency financial interest comprising a price term expressed in a first currency, the method automatically presents terms for a proposed transaction in at least two currencies, including the first currency. The proposed transaction is preferably executable by entry of one or more commands at the user station, and may be subject to confirmation.

Such embodiments are useful, for example, for hedging the user's risk against fluctuations in currency exchange rates during the period of time between entry of the order and actual closing and settlement of an executed trade, or for facilitating direct payment or for other purposes.

Orders for trades in financial interests according to the invention may include soft, or negotiable, orders, indications of interest, and/or firm trade proposals. Orders may include market orders, such as offers to buy or sell, or acceptance of previously-proposed trades, such as hitting or lifting of previously-made bids or offers. Orders may be for straight sales, auctions, or other types of transactions.

In some embodiments, presentation of an option to engage in a currency transaction is triggered by a comparison, made by the trading system, of a currency known to be used by or preferred by, or otherwise associated with, the trader entering the order for the trade in the first interest with a currency used in stating terms of the trade referred to in the communication, or associated with a user station associated with the trade order. For example, a trader known to make payments or to prefer trading in United States dollars may be prompted to consider, and provided the opportunity of entering, a currency exchange for dollars and Yen upon entry of an order to purchase bonds in a Japanese market or on terms otherwise stated in Yen. Thus the invention provides methods of providing users of an electronic trading system opportunities for currency exchange related to transactions in other interests, wherein a communication by the user concerning a proposed or accepted trade in a financial or other interest comprises terms stated in a first currency. Such methods comprise associating with the user a preference for trading in a second currency, as for example by creation of user-preference data profiles, and presenting an opportunity to engage in a currency transaction comprising an exchange of the first and second currencies.

Embodiments of the invention that provide users of electronic trading systems with opportunities for currency exchange related to transactions in other interests may facilitate trading of currencies between various users of the system, or between users of the system and one or more currency exchanges outside the trading system. For example, such systems can facilitate trading between stock traders using an electronic trading system according to the invention and either the service provider who provides the trading system, each other, or, through suitable communications links, banks or other currency traders who are not functionally, contractually or otherwise affiliated with the trading system service provider.

One manner in which systems according to the invention provide users with opportunities to engage in transactions for currencies or other related interests is by displaying, as for example on a user's terminal, a selectable link to an electronic currency exchange system. In such embodiments, the user is enabled to select the link, such as a hypertext link to a uniform resource locator (URL) or other computer address, using a standard computer interface controller such as a keyboard, mouse, trackball, or other device. Selection of the link causes the system to access data files and/or programs associated with the link, which cause the user to be presented with interfaces for proposing, and, at the option of the user, accepting trades in currencies and other interests.

Additional features include presenting users, or automatically presenting at terminals associated with proposed trades, data comprising terms, as for example proposed price and quantity terms, and presenting such proposals in such form that they are immediately acceptable, or executable, by the user to whom they are presented. For example, a proposal may be presented with complete terms and a selectable “accept” or “execute” option, or other suitable means for accepting the proposed transaction. Presentation of proposed trades in such formats is sometimes referred to as using electronic trading tickets.

Other aspects of the invention comprise methods, systems, and programming for automatically providing to users of electronic trading systems opportunities for reviewing, confirming, and entering hedging transactions in financial and other interests. Such methods comprise, for example, automatically presenting, at a user station associated with an order for a trade in a first financial interest, prompts or terms for a proposed transaction in a second financial interest, the proposed transaction executable by entry of one or more commands at the user station. Terms for the proposed transaction, including an identification of the second interest, a quantity term, and/or a price term may be provided by default, and any or all of them may be firm or negotiable.

Such methods are useful, for example, for trading present, future, and contingent interests in stocks, bonds, commercial paper, negotiable interests, debt instruments, commodities, and energy interests.

Such methods may also be useful when presentation of the proposed hedging transaction, including for example the identity of the interests to be traded and price and quantity terms, is conditioned upon a relationship between the first and second financial interests specified by the user. For example, the presentation of proposed transactions may be conditioned upon the identity of the first interest, as for example where it is determined by users or providers of the trading system that risk associated with a stock purchase may be reduced by simultaneous purchase of a particular bond. Or for example quantity and price terms for a hedging transaction involving options in stocks may be determined based upon rates of change of prices in the options compared to rates of change of prices in an underlying stock. The specification of such relationships is well known, and will be well within the ability of those of ordinary skill in the relevant arts once they have been made familiar with this disclosure.

In other aspects the invention provides systems and computer program products for implementing the methods disclosed herein.

Additional aspects of the present invention will be apparent in view of the description which follows.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 is a schematic diagram of a system for presentation of or prompting for complementary transactions in financial interests according to a preferred embodiment of the invention.

FIG. 2 is a schematic diagram of a process for presentation of or prompting for complementary transactions in financial interests according to a preferred embodiment of the invention.

FIGS. 3-7 are examples of user interface screens useful in implementing preferred embodiments of the invention for presentation of or prompting for complementary transactions in financial interests according to a preferred embodiment of the invention.

### DETAILED DESCRIPTION OF THE PREFERRED EMBODIMENTS

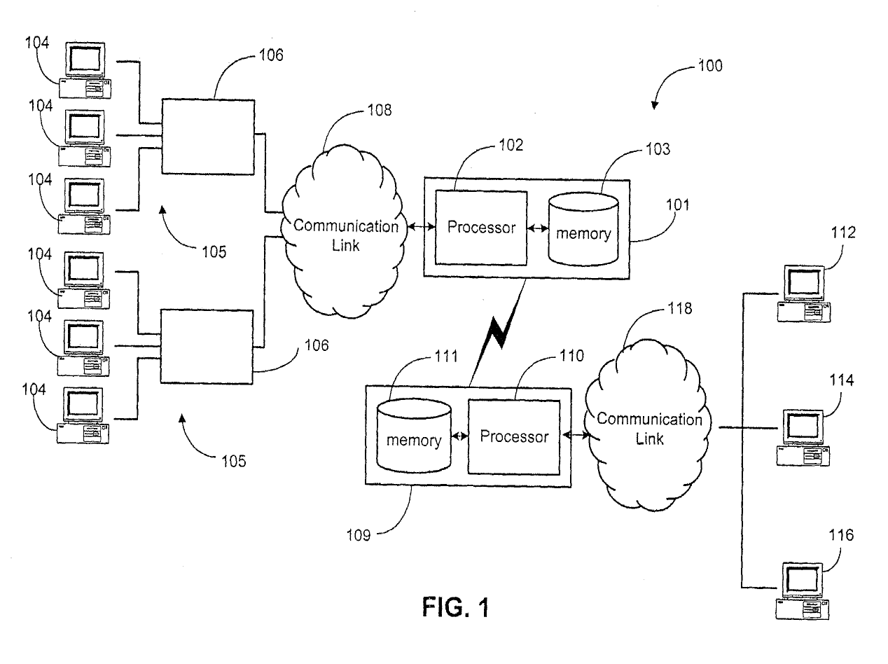

Referring to FIG. 1, a system 100 for presentation of or prompting for complementary transactions in financial interests according to a preferred embodiment of the invention includes one or more trading system server(s) 101 having at least one processor 102 and at least one memory 103, the server(s) connected to one or more client systems 105 via a communications network 108. Trading system server(s) 101 may be operated by a financial services system operator such as Bloomberg L.P. Client systems 105 optionally include one or more user stations 104 connected to one or more client servers 106. The client servers 106 may be operated, for example, by financial trading firms, and the user stations 104 operated by individual traders. The client servers 106 are connected to the user terminals 104 by any suitable communications link, such as a wired and/or wireless local or wide area network (LAN or WAN). The communications network 108 comprises any suitable communications link(s), such as a wired and/or wireless private network, e.g., LAN or WAN, etc., or a public network, e.g., the Internet, etc.

Client systems 105, as will be readily understood, may also comprise stand-alone user stations 104, liked directly to communications link 108 without intervening components such as client server(s) 106.

System 100 may also include one or more foreign exchange servers 109 having at least one processor 110 and at least one memory 111, the foreign exchange server(s) 109 connected to at least one foreign exchange terminal 112, 114, 116 via a communications network 118, or by any other suitable communications link(s). The foreign exchange terminal may be operated by a trader 112, an institution 114, a bank 116, etc. Foreign exchange server 109 is connected to trading server(s) 101 via a suitable communications link, as described above. Communications networks 108, 112 may be the same, related, or different communications links.

The identification and/or implementation of suitable foreign exchange server(s) 109, and/or terminals 112, 114, 116, and suitable communications links, will be well within the ability of those of ordinary skill in the relevant arts, once they have been made familiar with this disclosure.

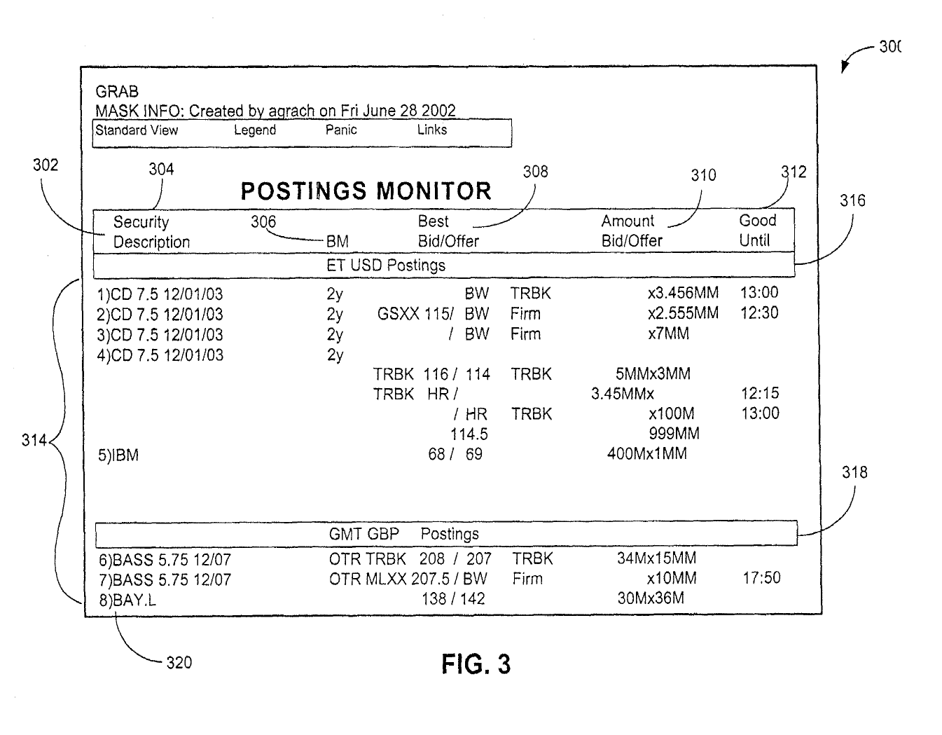

User stations 104 and foreign exchange terminals 112, 114, and 116 preferably include programming allowing users to submit communications concerning trades in financial interests, e.g., to post order orders to trade financial interests, receive communications from the trading server(s) 101 and/or foreign exchange server(s) 109, and to display interface screens and to carry out other input/output functions for accomplishing such functions. Trading server(s) 101 and/or foreign exchange server(s) 109 preferably include programming enabling reception and processing of such communications, orders, etc., and for enabling input and output by traders to the financial trading system, as for example by causing interface screens such as those described herein to be displayed at the various user terminals 104 and/or foreign exchange terminals. The servers further include associated databases or other memory(ies) for storing user and trading information, etc. For example, communications concerning a trade in at least one financial interest, such as an order to buy or sell a particular security may be transmitted from user terminal 104 and correspondingly received at trading server(s) 101. Trading server(s) 101, may then present the user with an option to engage in a related financial transaction, for example, by presenting terms of a proposed transaction, or a suitable prompt. Proposals may be offered automatically or presented upon request or inquiry from the user, e.g., in response to a prompt. A proposal may be provided in a variety of ways, such as for example, with trading server(s) 101 prompting or causing to be displayed an interface screen or screens, such as those described in connection with FIGS. 3-7, at the user terminal 104, allowing the user to enter into and/or confirm related financial transactions, such as related currency trades. The related financial transactions may be executed based on information in the trading server(s) 101 alone and/or in combination with any foreign exchange server(s) 109.

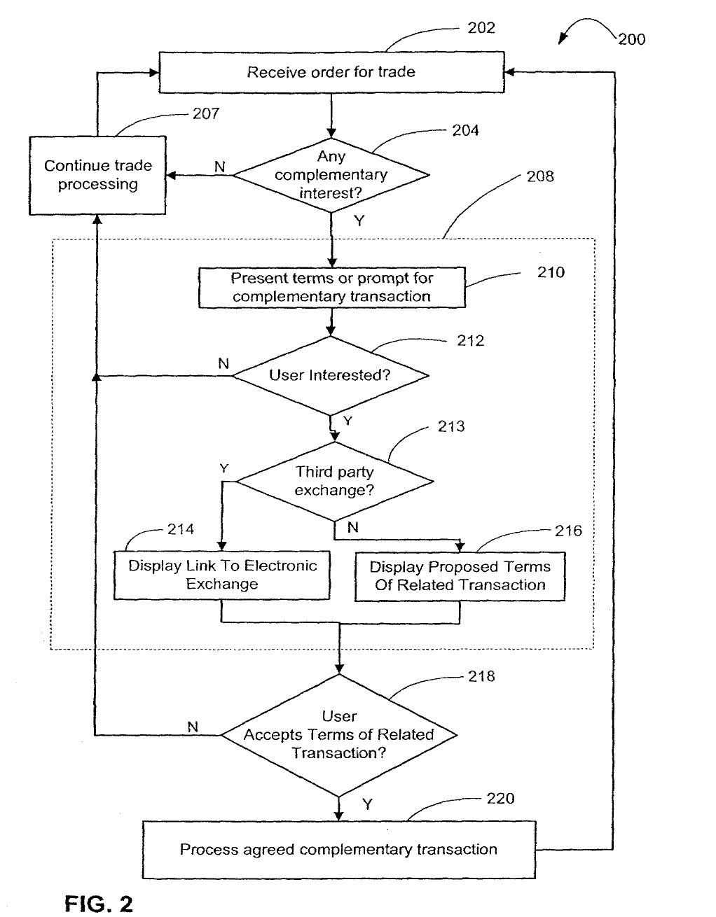

FIG. 2 is a schematic representation of a process 200 for presentation of or prompting for complementary transactions in financial interests according to a preferred embodiment of the invention, suitable for implementation using a system such as that shown in FIG. 1. The process of FIG. 2 illustrates the invention through presentation and processing of a proposed currency exchange transaction to complement a trade in other financial interests.

Process 200 begins at 202 with reception by trading system server(s) 101 of an order for a trade in a financial interest posted by a user station 104. Terms for the trade order may be input and transmitted to the system in a variety of ways, such as, for example, displaying an interactive financial interest trading screen at a user station 104, or at one or more of foreign exchange terminals 112, 114, 116, followed by writing or other transmission of the data to the trading system. The interface screen may be provided with proprietary software running at the user station 104, the trading server(s) 101, or any combination thereof, in conjunction with or via web browser applications, such as Explorer, Navigator, etc. Alternatively or in addition, the trade order may be transmitted to the trading system, such as to trading server(s) 101 and/or foreign exchange server 109, in an e-mail message, via an interactive voice response system, or any other suitable means for communicating information to trading server(s) 101 and/or foreign exchange server(s) 109.

Users of the system can include, for example, traders proposing or executing trades in securities or other financial interests, such as present, future, or contingent interests in stocks, bonds, contracts, debt instruments, commercial or other types of paper, via the user terminal. Thus, orders for trades can include, but are not limited to, offers to purchase or sell financial interests, such as for example, offers to buy or sell stock in a company. Terms of offers to buy or sell financial interests typically include a quantity and a price, the price being stated in a currency such as US dollars, euros, or UK pounds.

Upon receiving from one of user stations 104 the communication concerning a trade in a financial interest, at 204 trading server(s) 101 determines whether there exists a complementary or related financial interest, in particular, for the illustrated example, a related or associated currency, that has been identified as suitable or desirable for a transaction to be conducted in conjunction with the received order, or as preferred by the user entering the trade order. For example, a trader using the user station may have identified one or more related interests, such as options or currency forwards or swaps, as desirable for trading in connection interests identified in the proposed trade. Or, for example, a user profile associated with the trader or the user station may indicate that the trader usually trades in a first currency, while a price term associated with the proposed trade is stated in terms of a second currency.

For example, a trading system according to the invention may provide unique identifiers, such as user, firm, station, and/or session identification numbers, and store them in memory associated with the user, firm, station, and/or user, as for example in user, firm, etc., profiles, session databases or record files, etc., with data indicating various user customs or preferences, such as preferred currencies and/or financial interests for trading. For example, a preferred currency may be specified when a trader establishes a trading account for using the trading system, or at any time thereafter.

The identification of additional examples of complementary or related interests and the association, storage, retrieval, and use of such interests and other user preferences with individual users, firms, stations, or sessions are well understood, and will be well within the ability of those skilled in the related arts, once they have been made familiar with this disclosure.

If for example a user has entered a trade order to buy or sell a particular stock being traded on the London Stock Exchange in United Kingdom pounds (“GBP”) or Euros (EUR), and the user or the user station from which the order is received is associated with a preferred trading currency of United States Dollars (“USD”), the at 204 trading system 101 identifies USD as a related interest, and can cause the user station from which the trade order was received to present terms for a proposed trade of USD for GBP, or a prompt requesting whether the user would like to consider such a trade.

If at 204 trading server(s) 101 determines that there is no interest identified or identifiable as possibly of interest for a complementary transaction, the trading system 100 continues processing the trade order at 207 without presenting terms for a complementary transaction, and repeats steps 202-204 for subsequently-received orders. If at 204 a related interest is identified, at 208 system 100 presents at the associated user station 104, preferably automatically, an option to engage in a complementary financial transaction, as for example by presenting terms for a proposed currency exchange, or a suitable prompt.

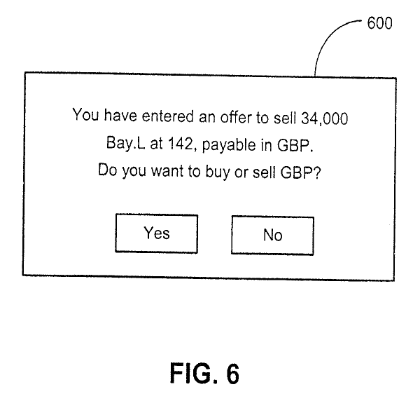

Presentation at a user station 104 of an option to engage in a related financial transaction may be accomplished in any one or more of a variety of ways. For example, in some embodiments, at 210 the system provides a prompt as part of a user interface screen displayed at the user station 104, the prompt offering a user at the user station an option to view terms for a related financial transaction. The prompt may be presented to the user by the trading server(s) and/or foreign exchange server causing a pop-up window or an interactive interface screen, alone or in combination with programming at the user station. In one embodiment, the window or screen recites the terms provided in the communication and inquires whether the user is interested in a related financial transaction, as for example as shown in FIG. 6 (discussed below). Alternatively terms for a proposed transaction are automatically displayed, as for example as described below at 216, without first providing a prompt or other inquiry to determine interest on the part of the affected user.

At 212 the system determines whether the user wishes to proceed with a proposed related transaction, or with presentation of proposed terms for such a transaction. If the user indicates that he is not interested in a related transaction, at 207 the system proceeds with processing of the trade order received at 202 and repeats the cycle of reviewing trade orders and determining whether to present terms for a proposed trade as other new trade orders are received.

If at 212 the user has indicated interest in a related financial transaction, or if the prompt process of 210, 212 has not been implemented, the user is presented directly or indirectly at 214, 216 with terms for a proposed complementary transaction. The user can be presented at 214 with a selectable link to a third party exchange 109, and presented with proposed terms for a suitable complementary trade by the third party exchange. For example, upon activation of a desired selectable link from a list of third-party banks for currency exchange systems, trading system 101 can cause to be forwarded to exchange 109 data related to the proposed trade, as for example and indication of the interests to be traded, and a suggested quantity, in response to which selected exchange 109 can cause, directly or through trading system 101, terms for a suggested trade to be presented at the appropriate user station 104.

Alternatively, or in addition, the user is presented at step 216 with a window or interface screen that provides terms for the proposed related trade. Such terms may be presented as part of a firm, executable offer that may be accepted or executed by the user via the user terminal without the user providing additional terms. In some embodiments one or more of the terms of the proposed transaction may be negotiable. Trades on terms presented by system 101 may be completed between the user to whom the transaction has been proposed and system 101 or other users at other stations 104.

At 218, the user is given an opportunity by system 101 or 109 to review the terms of the proposed related transaction, and to accept or reject them, or in some embodiments to negotiate one or more of the proposed terms.

If the user ultimately does not accept terms for the proposed transaction, at 207 the system continues processing the order received at 202.

If the user does accept terms for the proposed transaction, at 220 the trade is processed. Acceptance of the proposed transaction by the user may be conditioned upon receipt by system 101 of a confirmation from the relevant user station 104.

FIGS. 3-7 are examples of user interface screens useful in implementing preferred embodiments of the invention for presenting terms of or prompts for complementary transactions in financial interests according to a preferred embodiment of the invention, suitable for implementation according to systems and processes such as those shown in FIGS. 1 and 2.

Screen 300 of FIG. 3 represents a typical market screen for a bond trading system, showing market orders received by system 101 from a plurality of user stations 104 for the buying and selling of corporate bonds. Header bar 302 provides identification headings for columns containing data relating to pending orders for bond trades, including orders to buy (bid) and sell (offer) bonds. Heading 304 identifies a column of securities descriptions used to identify particular bond instruments offered for buying and selling in the depicted market.

The column headed by descriptor 306 identifies benchmarks used for making price comparisons and/or price determinations, for example US treasury bonds, which are sometimes used as benchmarks in US corporate bond markets. Column 308 lists best bids and offers for the bonds identified in column 304, and provides an indicator of the source of the bid/offer, such as the TRADEBOOK® (TRBK) trading system provided by BLOOMBERG LP. Column 310 indicates the amount, or quantity, terms associated with the listed orders. Column 312 provides, where applicable, time limits imposed for acceptance of the listed orders.

In the example shown in FIG. 3, all orders are firm and executable. That is, a trader at a user station 104 to whom such a screen is displayed is able to select and thereby accept any one of the bids and offers shown, without negotiating terms, acceptance of any of the bids and offers results in execution of a trade at the stated terms.

The interface screen represented in FIG. 3 also includes separator bars 316 and 318 to help viewing traders distinguish between various markets. For example, bids and offers listed below separator bar 316 and above separator 318 comprise prices stated in USD and Eastern Standard Time (EST); prices for orders listed below separator 318 are stated in GBP and times in Greenwich Mean Time (GMT). For example, relevant information for listing 320 for a lot of bonds issued by the company British Airways (BAY.L), includes information for a best bid at 138 basis points above the current price of the benchmark OTR, payable in GBP, for a lot of having an aggregate 30M GPB par value, and a best offer of 142 basis points for a lot 36M aggregate par value.

Preferably, the information displayed in the screen depicted in FIG. 3 is updated on a continuous basis in real time.

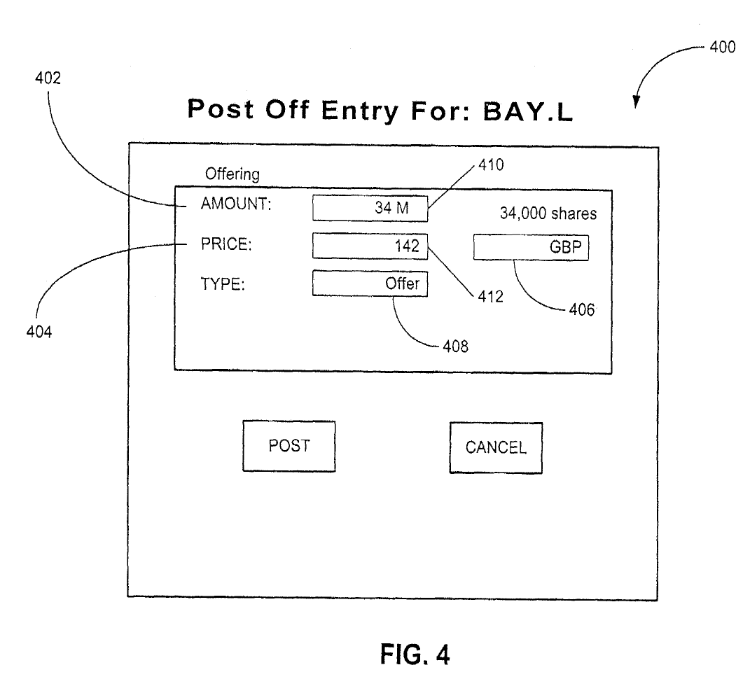

A trader or other user at a user station 104 may enter an order for a trade at any time by calling up an order entry screen such as that shown in FIG. 4. For example, such a user may position a cursor over a bid or offer portion of the screen of FIG. 3, and “select” such a portion by activating a switch associated with the cursor, such a button on a mouse, trackball, or other pointing device. Such selection methods are sometimes referred to as “point and click” methods. Doing so in the manner described results in presentation at the user station of a screen such as that shown in FIG. 4.

Terms stated in or otherwise associated with orders for trading of financial interests are generally dependent of the type of financial interests for which the orders are being posted. For example, a posting for an order of a stock typically includes an identification of the stock to be traded, a price term, such as a specific price in a particular currency, an amount or quantity, an indication of whether the order is a bid or an offer, and sometimes term indicating the duration of the offer, a good until date, a term indicating whether the order or any of its terms are firm or negotiable, etc. Processes suitable for identifying suitable terms for implementing the invention for particular interests to be traded in systems according to the invention is well understood, and will be well within the ability of those of ordinary skill in the relevant arts once they have been made familiar with this disclosure.

Screen 400 depicted in FIG. 4 is adapted for entry of an order to sell bonds. By selecting a portion of screen 300 in FIG. 3, a user can cause presentation of such a screen. If the trader wishes to buy bonds, the trader can select a portion of the “buy” or “bid” portion of screen 300.

Screen 400 comprises fields 410, 412, 406, for interactive input of amount, or quantity; price, and currency terms, respectively. Terms may also be entered, as will be appreciated by those familiar with the relevant arts, by use of pull down menus or other selectable items provided by trading system 101 at user station 104.

The input screen of FIG. 4 further comprises field 408 for specifying the type of order to be posted, thus offering the entering user an opportunity to override the default provided by selection of the “offer” portion of screen 300.

For example, a user wishing to enter an offer to buy 34M par value of British Airways Corporate bonds at 142 basis points above the current benchmark price may do so by placing the cursor over the “buy” portion of screen 200, adjacent to an identifier for the appropriate bond, and by placing the cursor over or otherwise selecting the associated input fields 406, 408, 410, 412, and entering appropriate data.

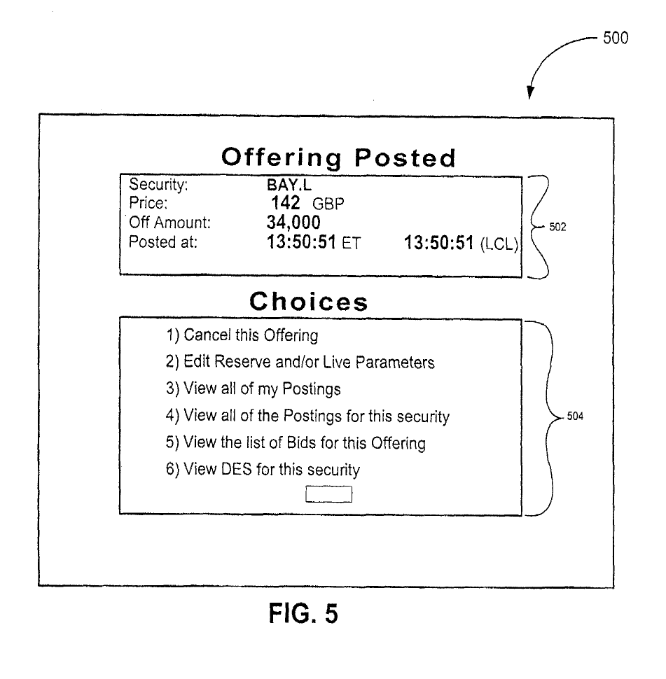

Selection of the “POST” item of screen 400 causes the entering user's user station 104 to send or release the entered terms to trading system 101 for posting as an order. Upon receipt of the order, system 101 stores the trading data in suitable memory, for use in preparing market screens provided to other traders and when appropriate further processing for completing trades, and causes user station 104 to present a screen such as that shown in FIG. 5, confirming at 502 posting of an order on the terms described above in connection with FIG. 4. At 504 the screen further provides the user an options menu 504 that allows a user to navigate to other interface screens allowing the user to cancel the order, edit the order, view other orders pending for the user, view other orders for the particular financial interest, etc., by entering the indicated item number 1)-6).

Upon entry by the user of the order confirmed in FIG. 5, system 101 further determines that the order is payable, if accepted by another user and executed, in GBP. The system further determines, from a preference or user profile associated with the user that originated the order (who identified himself, for example, by logging in using a user identification number at the beginning of his trading session, or by providing an identification number as part of the order) or with the user station from which the order was received, that a preferred currency for the order maker is USD. Thereupon the system causes the user station 104 to present a screen such as that shown in FIG. 6. The system causes the screen to be presented automatically, without any further input from the user entering the order.

User interface screen 600 of FIG. 6 provides the user entering the order with an opportunity to buy GBP, as for example as a hedge or to facilitate payment for an executed transaction. The user is provided the option of reviewing terms for a proposed transaction by selecting the “YES” icon, or of declining the transaction by selecting the “NO” icon, for example, by using point and click methods. Selection of the “NO” icon results in presentation to the user of any suitable further screen, such as for example a market view screen 300 such as that shown in FIG. 3.

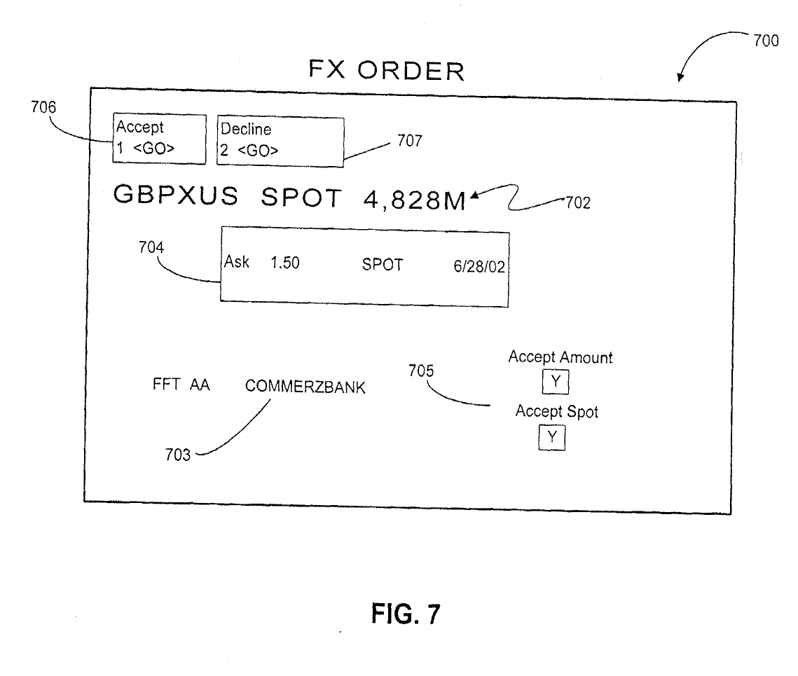

Selection of the “YES” icon in FIG. 6 results in presentation of a screen such as that shown in FIG. 7.

In the example depicted in FIG. 7, an executable proposal for a spot transaction for buying GPB with USD is presented. This order is provided by trading system 101 on behalf of a currency trading system 109, or by currency system 109 via trading system 101. The selection of a suitable market maker, or trading partner, for presentation of the proposed transaction may be made in any suitable fashion. For example, trading system 101 can make the proposal on its own behalf, or user station 104 may be provided with a list of available currency trading parties, such as banks, or a user or administrator associated with user station 104 may pre-designate one or several preferred trading partners.

Screen 700 of FIG. 7 provides terms for a proposed GBP-USD spot currency transaction. At 704 a price term of 1.50 GPB per dollar is proposed, for a quantity of 4.828 M GPB, as shown at 702. Proposed price and quantity terms may be provided in any suitable fashion. For example, where the proposal is made by or on behalf of a currency exchange, the price may be set at the midpoint of current best bid/offer, at or at some predetermined offset from best bid offer, etc. Quantity terms may be determined using any number of well-known analytical methods for converting the stated price of the original posted trade order into a suitable corresponding spot currency price. Means for setting proposed terms will be well within the ability of those familiar with the relevant arts once they have been made familiar with this disclosure.

At 703 the counterparty to the proposed transaction is identified, and at 705 the user to whom the proposal is presented is offered the option of requesting or negotiating either the price or quantity terms.

If and when the user is satisfied with the proposed transaction, he/she may accept by selecting “Accept” icon 706, or decline by selecting “Decline” icon 707.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product which cause can cause a general-purpose computer to operate as a special-purpose computer, in accordance with the disclosure herein. Such program product implemented on a general-purpose computer constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of configuration parameters which are often unique to the operating system(s) used by the computer. When so configured, the special-purpose computer device has an enhanced value, especially to the professional users for whom it may be intended.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

What is claimed is:

1. A method of providing to users of an electronic trading system opportunities for currency exchange related to transactions in other financial interests, the method comprising presenting, at a user station of the electronic trading system associated with an order for a trade in a non-currency financial interest comprising a price term expressed in a first currency, terms for a proposed transaction in at least two currencies, the at least two currencies comprising the first currency and the proposed transaction executable by entry of one or more commands at the user station.

2. The method of claim 1, wherein the at least two currencies include at least one currency associated as a default with the user station as a preferred currency.

3. The method of claim 1, wherein the terms for the proposed transaction include a quantity related to the price term expressed in the first currency.

4. The method of claim 1, wherein at least one of the terms for the proposed transaction is firm.

5. The method of claim 1, wherein the presenting of terms for a proposed transaction in at least two currencies is automatic.

6. A method of providing to users of an electronic trading system opportunities for hedging transactions in financial interests, the method comprising presenting, at a user station of the electronic trading system associated with an order for a trade in a first financial interest, terms for a proposed transaction in a second financial interest, the proposed transaction executable by entry of one or more commands at the user station.

7. The method of claim 6, wherein the terms for the proposed transaction include by default at least one of an identification of the second financial interest, a quantity term, and a price term.

8. The method of claim 7, wherein at least one of the default terms is negotiable prior to entry of an execution command at the user station.

9. The method of claim 7, wherein at least one of the terms of the proposed transaction is not negotiable.

10. The method of claim 6, wherein the first and second financial interests comprise at least one of present, future, and contingent interests in stocks, bonds, commercial paper, negotiable interests, debt instruments, commodities, and energy interests.

11. The method of claim 6, comprising conditioning the presenting to the user an option to engage in a trade in a second financial interest upon a relationship between the first and second financial interests.

12. The method of claim 1, wherein the presenting of terms for a proposed transaction in at least two currencies is automatic.

13. A system for electronic trading of financial interests over a computer network, the system comprising at least one computer for processing data related to trading of financial interests over the computer network, a plurality of user stations for entry of orders for trades in financial interests, and programming stored on a computer readable medium or media that causes the at least one computer to present, at a user station associated with an order for a trade in a non-currency financial interest comprising a price term expressed in a first currency, terms for a proposed transaction in at least two currencies, the at least two currencies comprising the first currency and the proposed transaction executable by entry of one or more commands at the user station.

14. Computer program product stored on a computer readable medium or media and useable for causing a computer system to present, at a user station associated with an order for a trade in a non-currency financial interest comprising a price term expressed in a first currency, terms for a proposed transaction in at least two currencies, the at least two currencies comprising the first currency and the proposed transaction executable by entry of one or more commands at the user station.

15. A system for electronic trading of financial interests over a computer network, the system comprising at least one computer for processing data related to trading of financial interests over the computer network, a plurality of user stations for entry of orders for trades in financial interests, and programming stored on a computer readable medium or media that causes the at least one computer to present, at a user station associated with an order for a trade in a first financial interest, terms for a proposed transaction in a second financial interest, the proposed transaction executable by entry of one or more commands at the user station.

16. Computer program product stored on a computer readable medium or media and useable for causing a computer system to present, at a user station associated with an order for a trade in a first financial interest, terms for a proposed transaction in a second financial interest, the proposed transaction executable by entry of one or more commands at the user station.
